(19) United States
(12) Patent Application Publication
(10) Pub. No.: US 2025/0347105 A1
(43) Pub. Date: Nov. 13, 2025

(54) FOAM-BASED TAPE FOR INSULATED PANELS

(71) Applicant: LOUISIANA-PACIFIC CORPORATION, NASHVILLE, TN (US)

(72) Inventors: NEIL FREIDBERG, LEBANON, TN (US); JUSTIN HOFFMANN, SUPERIOR, WI (US)

(21) Appl. No.: 19/203,952

(22) Filed: May 9, 2025

Related U.S. Application Data
(60) Provisional application No. 63/644,795, filed on May 9, 2024.

(51) Int. Cl. E04B 1/76; C09J 5/00; C09J 7/26

(52) U.S. Cl. CPC E04B 1/7625; C09J 5/00; C09J 7/26; C09J 2203/346; C09J 2301/124; C09J 2400/243

(57) ABSTRACT

A foam-based tape that is applied to the underlying structure at a location or locations where adjacent insulated structural sheathing panels or insulated siding panels meet and form a seam between adjacent edges. The tape may be two-sided, i.e., a foam core with both sides comprising an adhesive layer. The tape is applied to the underlying structure, which may be studs, framing, or an underlying structural sheathing layer, by operation of the adhesive on one side, then the liner on the opposite side is removed prior to installation of the overlaying panels. The overlaying panels are installed so that the seam formed between two adjacent edges lies along the foam tape, and is adhesively secured thereto. The foam core allows for sufficient compressibility of the tape to ensure the tape properly bonds to the underlying structural elements and the overlaying panels.

This application claims benefit of and priority to U.S. Provisional Application No. 63/644,795, filed May 9, 2024, by Louisiana-Pacific Corporation, which is incorporated herein in its entirety by specific reference for all purposes.

### FIELD OF INVENTION

This invention relates to a foam-based tape applied to the back surface of insulated siding or sheathing panels to ensure insulation continuity across seams between the insulated panels.

### BACKGROUND OF THE INVENTION

Building wall and roof assemblies are typically layers of several materials, each performing a single function, that are installed separately on the site in which the building is being constructed. Compatibility between the various layers creates challenges not only for the designer, but also for the installers.

A typical layer in most such assemblies in a wood panel product, or an integral composite engineered panel product, including, but not limited to, engineered wood composite products formed of lignocellulosic strands or wafers (sometimes referred to as oriented-strand board, or OSB). Products such as fiberboard and particleboard have been found to be acceptable alternatives in most cases to natural wood paneling, sheathing and decking lumber. Fiberboard and particleboard are produced from wood particles bonded together by an adhesive, the adhesive being selected according to the intended use of and the properties desired for the lumber. Oftentimes, the adhesive is combined with other additives to impart additional properties to the lumber. Additives can include fire retardants, insect repellants, moisture resistance, fungus resistance, and color dyes. A significant advantage of fiberboard and particleboard lumber products is that they have many of the properties of plywood, but can be made from lower grade wood species and waste from other wood product production, and can be formed into lumber in lengths and widths independent of size of the harvested timber.

A major reason for increased presence in the marketplace of the above-described product alternatives to natural solid wood lumber is that these materials exhibit properties like those of the equivalent natural solid wood lumber, especially, the properties of retaining strength, durability, stability, and finish under exposure to expected environmental and use conditions. A class of alternative products are multilayer oriented wood strand particleboards, particularly those with a layer-to-layer oriented strand pattern, such as OSB. Oriented, multilayer wood strand boards are composed of several layers of thin wood strands, which are wood particles having a length which is several times greater than their width. These strands are formed by slicing larger wood pieces so that the fiber elements in the strands are substantially parallel to the strand length. The strands in each layer are positioned relative to each other with their length in substantial parallel orientation and extending in a direction approaching a line which is parallel to one edge of the layer. The layers are positioned relative to each other with the oriented strands of adjacent layers perpendicular, forming a layer-to-layer cross-oriented strand pattern. Oriented, multilayer wood strand boards of the above-described type, and examples of processes for pressing and production thereof, are described in detail in U.S. Pat. No. 3,164,511 (Elmendorf, issued Jan. 5, 1965), U.S. Pat. No. 4,364,984 (Wentworth, issued Dec. 21, 1982), U.S. Pat. No. 5,425,976 (Clarke, et al., issued Jun. 20, 1995), U.S. Pat. No. 5,470,631 (Lindquist, et al., issued Nov. 28, 1995), U.S. Pat. No. 5,525,394 (Clarke, et al., issued Jun. 11, 1996), U.S. Pat. No. 5,718,786 (Lindquist, et al., issued Feb. 17, 1998), and U.S. Pat. No. 6,461,743 (Tanzer, et al., issued Oct. 8, 2002), all of which are incorporated herein in their entireties by specific reference for all purposes.

Certain oriented board products can be made from flakes that are created from debarked round logs by placing the edge of a cutting knife parallel to a length of the log and the slicing thin flakes from the log. The cut flakes are subjected to forces that break the flakes into strands having a length parallel to the grain of the wood several times the width of the strand. The strands can be oriented on the board-forming machine with the strands predominantly oriented in a single (e.g., cross-machine) direction in one (e.g., core) layer and predominantly oriented in the generally perpendicular (machine) direction in adjacent layers. The various layers are bonded together by natural or synthetic resins under heat and pressure to make the finished product. Oriented, multilayer wood strand boards of the above-described type are produced with bending, tensile strengths and face strengths comparable to those of commercial softwood plywood.

Building wall and roof assemblies typically are constructed by attaching several panels of the above-described type as to an underlying supporting structure frame as “sheathing.” These sheathing panels are often placed in a pattern with the edge of each panel contacting or positioned close to adjacent panels, thereby forming a substantially continuous flat surface. In certain types of construction, the panels (and other construction materials) may be required under applicable building codes to meet certain weather resistance or water resistance requirements.

In prior art applications, a manufactured wood panel is installed as sheathing at a job or construction site. After installation, a code-approved water resistant barrier (WRB) system or material is applied. Examples of these WRB systems include housewrap (e.g. Tyvek, Typar), peel-and-stick membranes, or a WRB fluid or liquid applied to the installed panel. However, these systems all rely upon skilled labor for installation at the job. In addition, many of the systems cannot be installed during inclement weather, and require the installed sheathing to be free of defects and provide a clean surface free of debris in order to achieve proper adhesion between the panel and the WRB. As a result, all of these systems can be problematic to install on a job site, and often result in improper installation causing failures in the building “envelope,” leading to problems such as moisture instruction or mold or mildew growth. Examples of installation failures include, but are not limited to, reverse lapping, inconsistent thickness of the applied WRB, and improper adhesion of the WRB to the panel. These prior art systems also increase safety risks at the job site, since the installer must handle bulky or clumsy materials at potentially high elevations for long periods of time. Installation of a WRB at a factory prior to transport and installation in the field also is known.

In many locations, some form of insulation is often required in a roof or wall construction, helping to protect and maintain the interior of a structure from high or low temperatures. Insulation typically is added during or after installation of structural panels, and may take the form of insulated siding or cladding panels. Examples of foam insulation board production and installation methods in various contexts are disclosed in U.S. Pat. No. 4,572,865 (Gluck, et al., issued Feb. 25, 1986); U.S. Pat. No. 5,695,870 (Kelch, et al., issued Dec. 9, 1997); and U.S. Pat. Pub. No. 2021/0348388 (Budinscak, Jr., Nov. 11, 2021), all of which are incorporated herein in their entireties by specific reference for all purposes.

Installation of an insulation layer to the interior side of a panel at a factory prior to transport and installation in the field also is known, such as LP NovaCore Thermal Insulated Sheathing, or Isolofoam Isobrace OSB. A structural insulated sheathing panel also is disclosed in Rudisill et al., U.S. Pat. Pub. 2021/0396010 (Dec. 23, 2021), which is incorporated herein in its entirety by specific reference for all purposes. This discloses an insulating layer, including foam polymer insulation, secured to the inward facing surface of a structural panel, with the opposite, exterior facing surface comprises a separate weather-resistant barrier (WRB) layer, in particular a resin-impregnated paper overlay. The gaps between the structural panels when installed on a structure are covered over with a sealant such as water-resistant seam sealant tape. A structural sheathing panel with a weather-resistant barrier (WRB), but without an insulating layer, also is disclosed in Bennett, et al., U.S. Pat. No. 9,010,044 (issued Apr. 21, 2015), which is incorporated herein in its entirety by specific reference for all purposes.

### SUMMARY OF INVENTION

Insulated siding (or cladding) panels are applied over an underlying building structure, such as, but not limited to, a structural sheathing panel or a sheathing panel with a weather-resistant barrier (WRB). Sheathing panels also may comprise insulated structural sheathing panels, which may be attached to an underlaying structures, such as, but not limited to, framing or studs. In various exemplary embodiments, the present invention comprises a foam-based tape that is applied to the underlying structure or structural components at a location or locations where adjacent insulated siding or structural panels meet, thereby forming a seam between adjacent edges. The tape may be two-sided, i.e., a foam core with both sides comprising an adhesive layer.

The tape is applied (adhered) to the underlying structure by operation of the adhesive on one side, then the liner on the opposite (outer) side is removed prior to installation of the insulated siding or sheathing panels. The panels are installed so that the seam formed between two adjacent edges lies along the foam tape, and is adhesively secured thereto. The foam core allows for sufficient compressibility of the tape to ensure the tape properly bonds to the underlying structural elements and the overlying insulated panels.

The foam tape helps create a continuous insulation envelope between the insulated panels, thereby preventing degradation of R-value between insulated panels. It also helps create a continuous moisture and vapor seal to assist in preventing moisture intrusion between the underlying structural elements and the overlying insulated panels. In several embodiments, the foam tape placement does not coincide with the seams between underlying structural sheathing panels, but only with the seams between overlying insulated siding panels.

### BRIEF DESCRIPTION OF THE DRAWINGS

FIGS. 1 and 2 show front and perspective views of a stud framework with seam tape installed on outer edge or surface of several studs and beams.

FIGS. 3 and 4 show front and perspective views of a panel installed on the right side of the stud framework of FIGS. 1 and 2.

FIG. 5 shows a top view of the stud framework with panel of FIGS. 3 and 4.

FIGS. 6 and 7 show front and perspective views of a quarter-panel installed on the right side of the stud framework of FIGS. 1 and 2.

FIG. 8 shows a cross-section view of a single-sided foam tape with a staple inserted therethrough.

FIG. 9 shows a cross-section view of a double-sided foam tape with a staple inserted therethrough.

FIGS. 10A and 10B show exploded views of a single-side foam tape and double-sided foam tape, respectively.

### DETAILED DESCRIPTION OF EXEMPLARY EMBODIMENTS

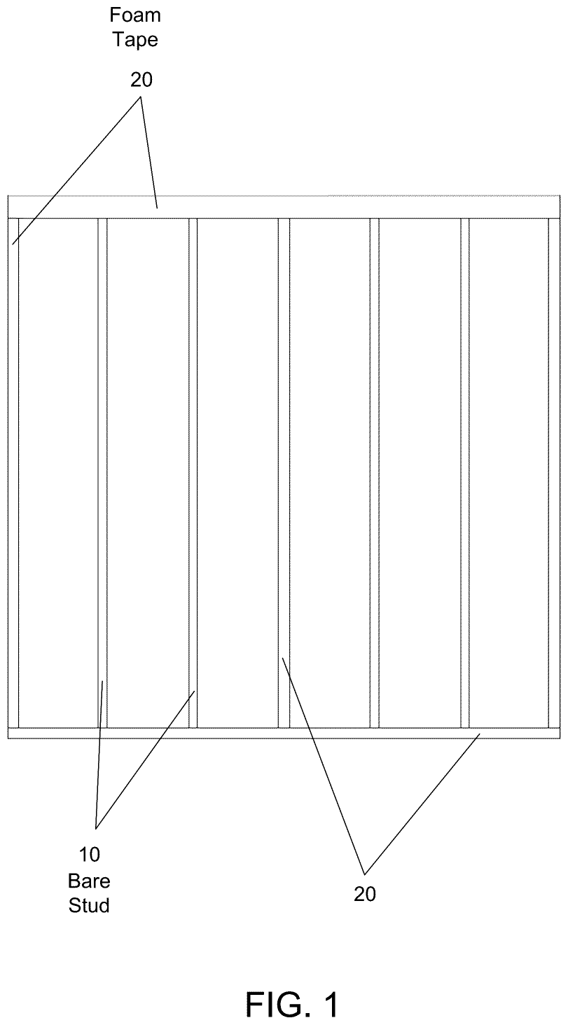

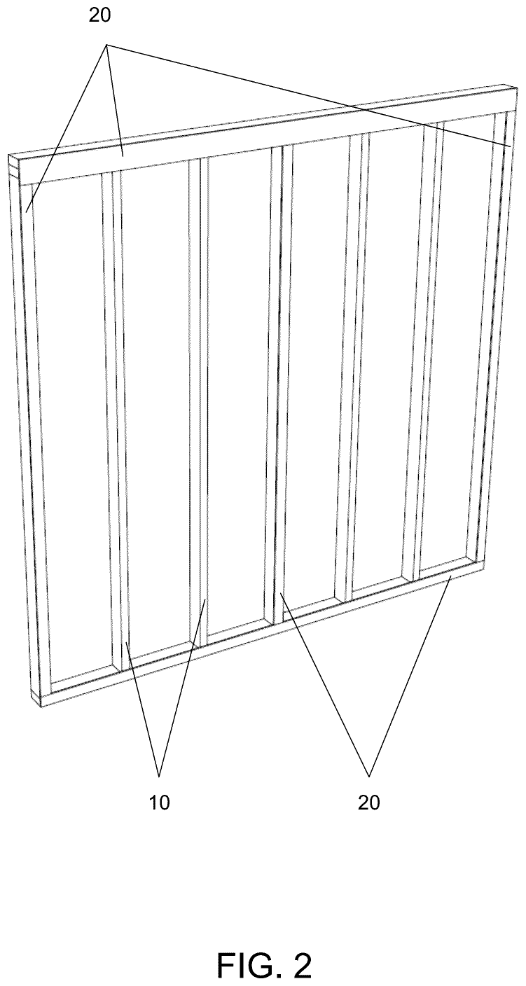

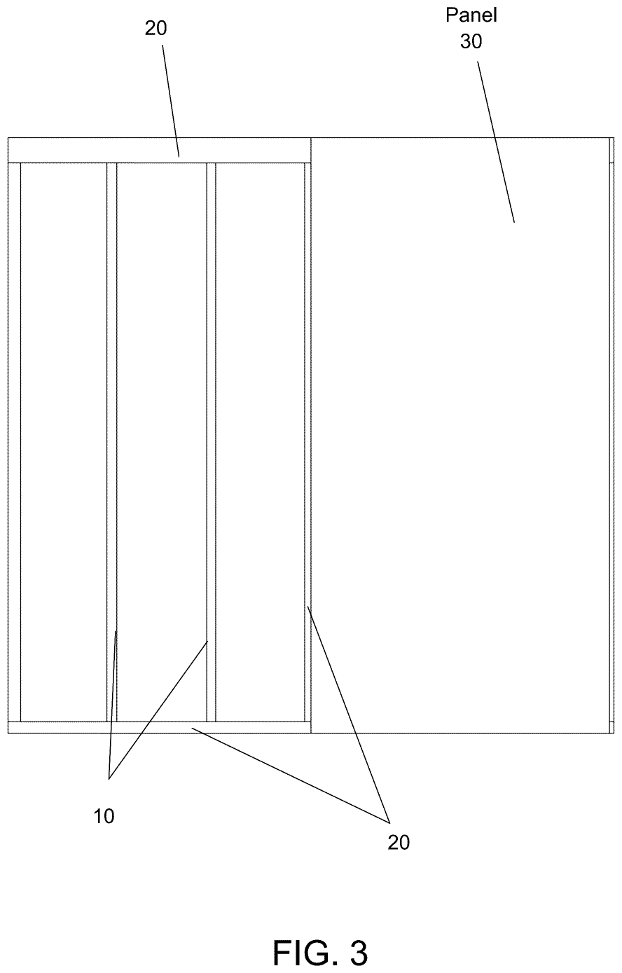

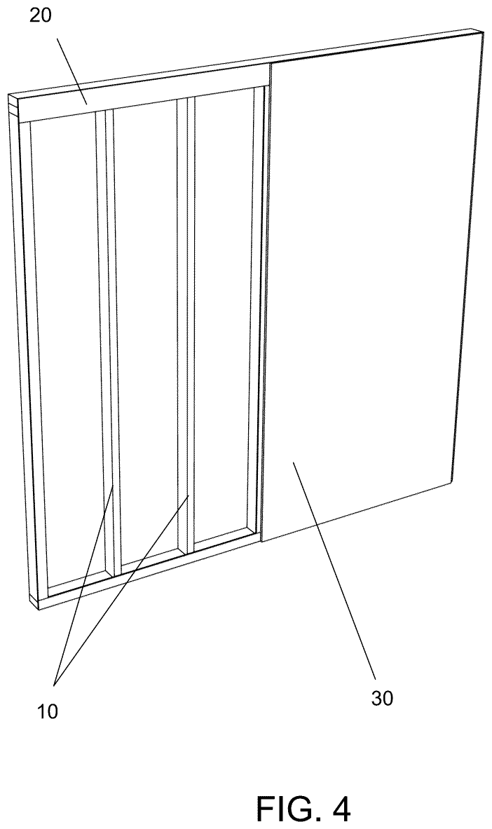

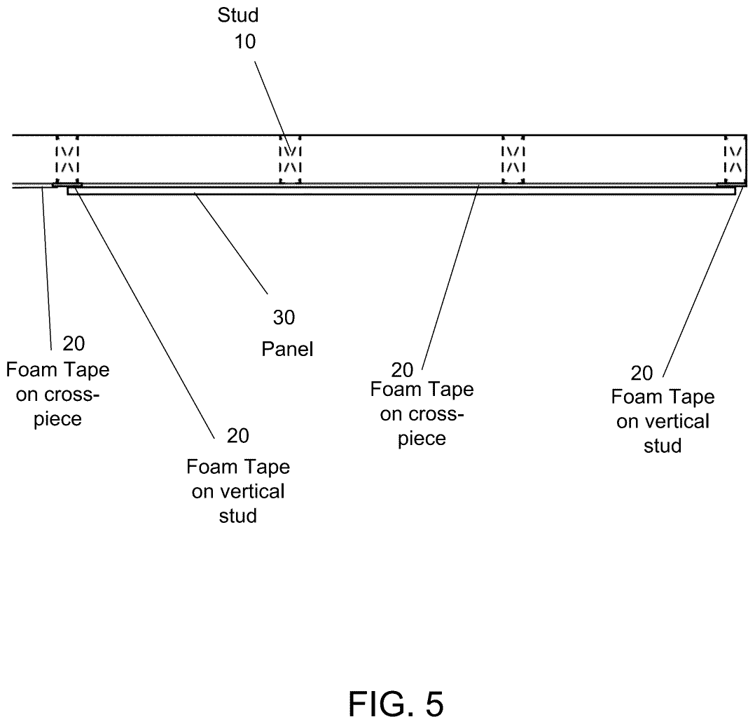

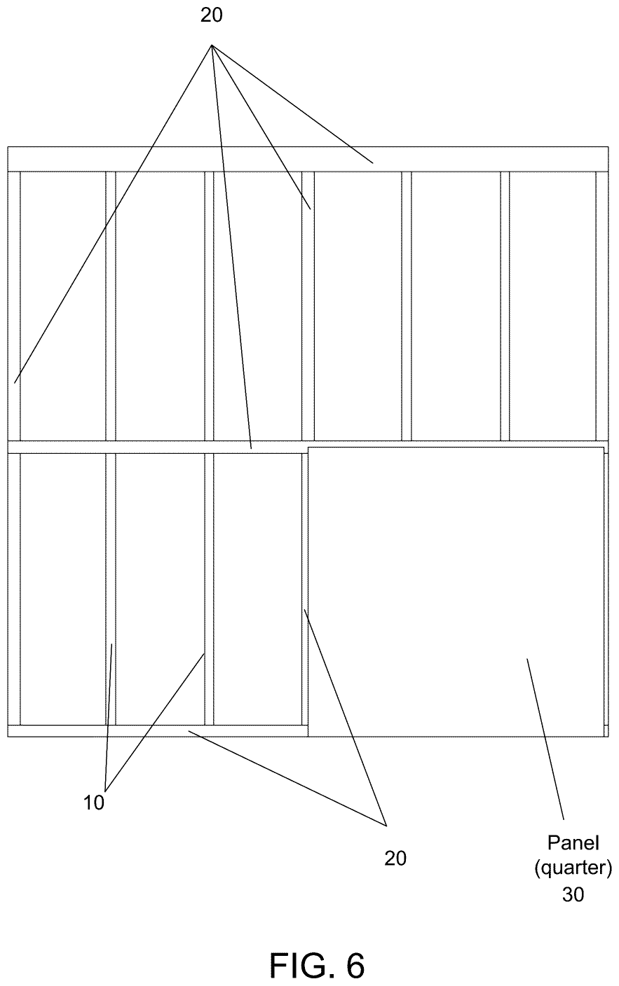

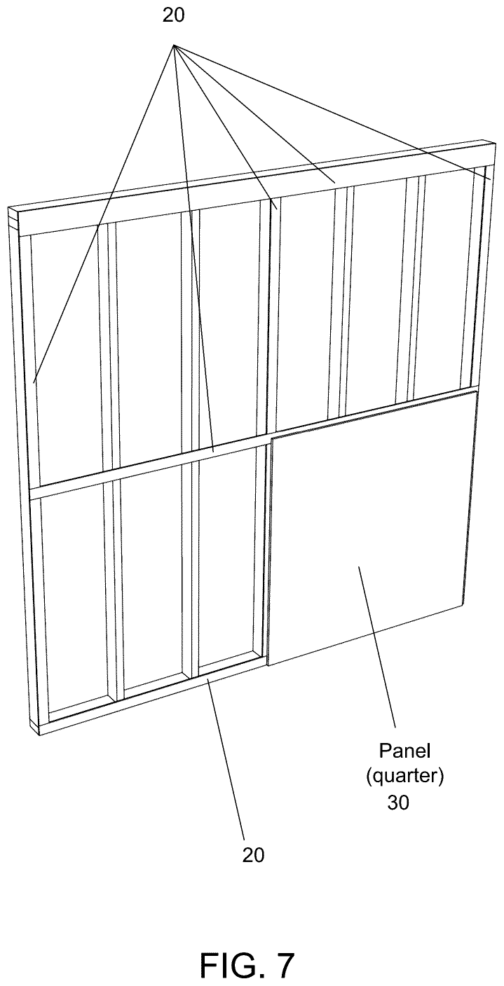

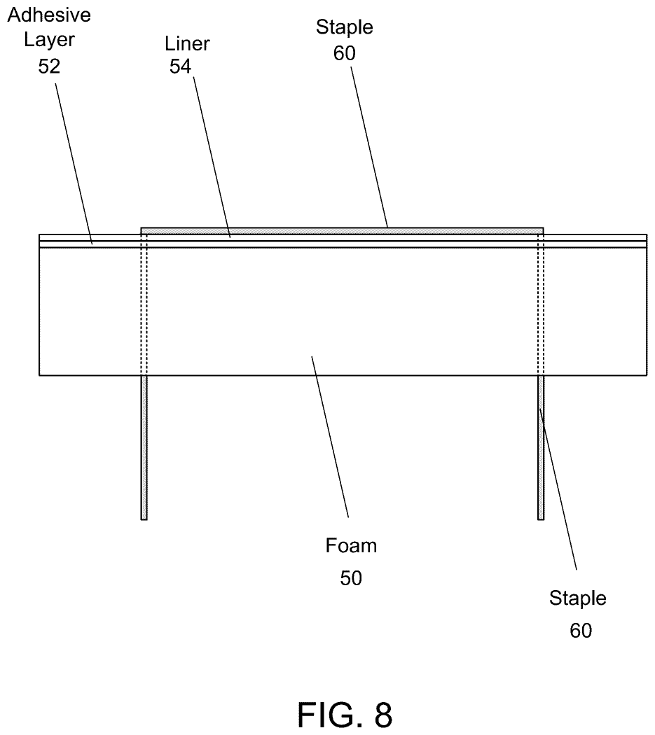

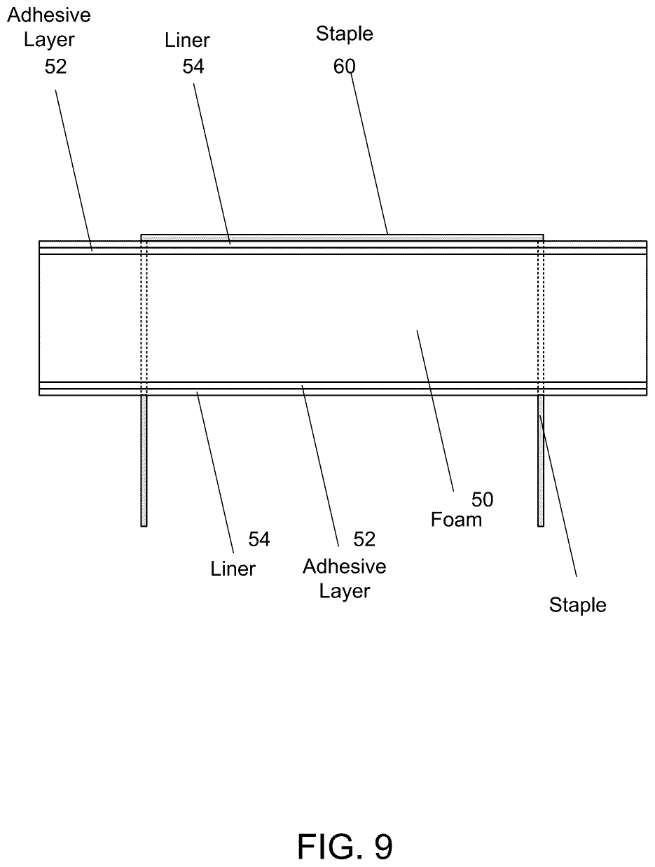

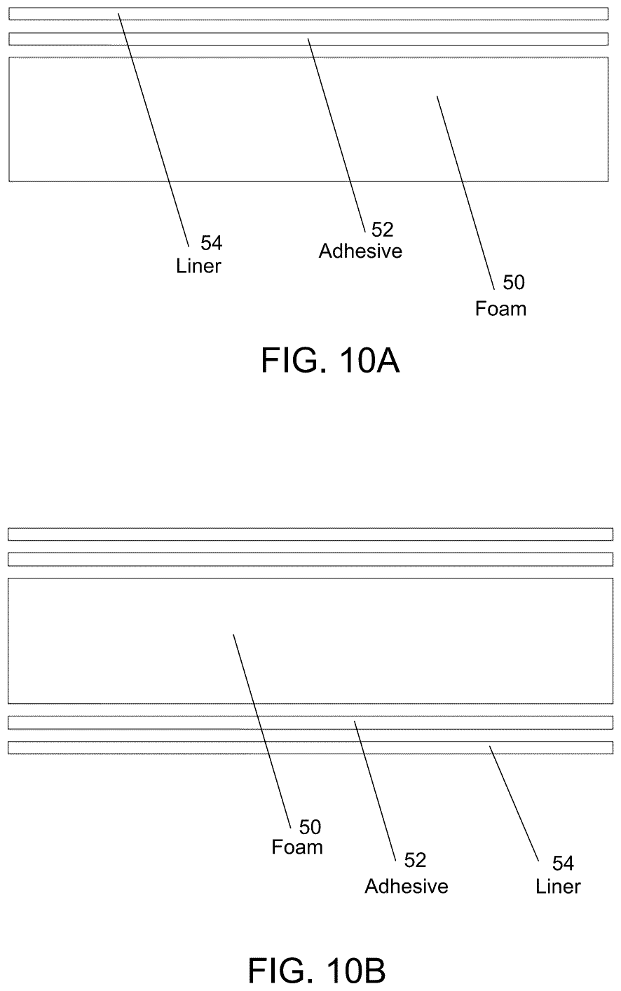

In various exemplary embodiments, as seen in FIGS. 1-7, the present invention comprises a foam-based tape 20 that is applied to an underlying structure or structural component (e.g., a structural sheathing panel layer, studs, and/or framing) 10 for residential and/or commercial construction, including, but not limited to, construction of a building or home, or a wall, floor, and/or roof thereof. The tape 20 is applied at a location or locations where adjacent insulated panels 30 meet, thereby forming a seam between adjacent edges. The insulated panels may be insulated structural sheathing (sheathing) panels or insulated siding panels.

The tape 20 may be one-sided or two-sided, i.e., a foam core 50 with one or both sides comprising an adhesive layer 52. The adhesive layer may or may not be lined (i.e. have a liner 54), and the adhesive layer may or may not be a pressure-based adhesive layer. In several embodiments, the adhesive layer 52 comprises a butyl-based, acrylic-based, or similar form of adhesive.

The foam may be foam insulation or foam polymer insulation. The foam may be expandable. The foam may comprise polyethylene foam, polyurethane foam, polyisocyanurate foam, polystyrene foam (including, but not limited to, and expanded polystyrene foam or extruded polystyrene foam), and other forms of p. The foam may may be bulk water impermeable, or substantially bulk water impermeable. The foam may be of any suitable thickness based upon the type of structure and panels used. In one embodiment, the foam ranges from ¼″ to 2″ in thickness, and has a width to cover the width of the joint as well as a portion of the back face of the overlying panels. In various embodiments, the foam core layer provides an insulation (thermal resistance) rating (i.e., R value). R value depends on the thickness of the foam layer (e.g., approximately R5 for every 1 inch of thickness). The foam tape thus provides insulation as well as acting as an air barrier and weather resistant or water resistant barrier (WRB).

The tape 20 is applied or adhered to the underlying structure or structural component 10 by operation of the adhesive on one side (if lined, the liner is first removed), then the liner on the opposite (i.e., outer) side is removed prior to installation of the overlying panels 30. The sheathing panels 30 are installed so that the seam formed between two adjacent edges lies along the foam tape, and is adhesively secured thereto. The foam core 50 allows for sufficient compressibility of the tape to ensure the tape properly bonds to the underlying structural elements and the overlying insulated panels.

In several embodiments, the tape may be used in conjunction with a fastener, such as a nail or staple 60 to help attach or secure the tape to a structural component or a panel.

The foam tape 2 helps create a continuous insulation envelope in conjunction with and between the insulated panels, thereby preventing degradation of insulation values (R-value) between insulated panels 30. It also helps create a continuous moisture and vapor seal to assist in preventing moisture intrusion between the underlying structural elements 10 and the overlying insulated panels 30.

In several embodiments, the foam tape placement does not coincide with the seams between underlying structural panels, but only with the seams between the overlying insulated panels. In further embodiments, the tape may be applied to the back (interior) side of a joint between the overlying insulated panels, even where there is no underlying structure or structural component. In this embodiment, pressure is applied from the back side of the overlying panels to ensure adhesion to the edges of those panels adjacent to the joint.

The tape may be used with insulated panels in various forms, including insulation foam on the interior of an insulated panel, on the exterior of an insulated panel, or on both faces of the insulated panel. In some embodiments, the tape also may be used with panels without an insulation layer, so as to help create a stronger building envelope as described above.

In a further exemplary embodiment, the tape may be metallicized or have a metallic layer on the side opposite the adhesive layer. This tape can then be used to seal joints between radiant barrier panels, which typically comprise a structural sheathing or roofing panel of manufactured wood with an inward-facing metallic film or layer on the interior face, typically aluminum. The metallic face of the tape faces inward as well, thereby presenting a consistent inward-facing metallic face of the panel structure.

A method for constructing a building structure using the tape of the present invention comprises the steps of: adhering an insulation tape to some or all of an outer surface of an underlying structure or structural component; fastening a first panel with an inner surface, an outer surface, and one or more edges to the underlying structure or structural component, wherein the first panel is positioned so that an edge of said one or more edges is aligned with the insulation tape, and a portion of the inner surface of the first panel extends over a portion of the insulation tape; and fastening a second panel with an inner surface, an outer surface, and one or more edges to the underlying structure or structural component, wherein the second panel is positioned so that an edge of said one or more edges is aligned with the insulation tape, and a portion of the inner surface of the second extends over a portion of the insulation tape, and wherein the first panel and second panel are affixed with the respective edges aligned adjacent and in proximity to each other to form a joint, and the insulation tape underlies the joint. Further, the step of adhering an insulation tape optionally comprises removing a first liner from a first adhesive layer on a first side of a foam core of the insulation tape, and pressing the first side against said outer surface of the underlying structure or structural component. Further, the method optionally includes the stop of, after the step of pressing the first side against said outer surface, removing a second liner from a second adhesive layer on a second side of the foam core of the insulation tape.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. An insulated panel system, comprising:
at least two panels, each panel comprising an outer surface, an inner surface, and one or more edges,
an underlying structure or structural component, wherein said at least two panels are affixed with a corresponding edge of each panel aligned adjacent and/or in proximity to each other to form a joint; and
a tape underlying the joint, said tape affixed to a portion of the underlying structure and affixed to a portion of the inner surface of the respective adjacent panels.

2. The system of claim 1, wherein the tape comprises a foam core layer with a first face and a second face, with a first adhesive layer on said first face.

3. The system of claim 2, wherein the tape comprises a second adhesive layer on said second face.

4. The system of claim 2, further comprising removable a first liner covering the first adhesive layer.

5. The system of claim 3, further comprising a second liner covering the second adhesive layer.

6. The system of claim 1, wherein the at least two panels comprise insulation siding panels and/or insulation structural sheathing panels.

7. The system of claim 1, wherein the underlying structure or structural component comprises one or more structural sheathing panels.

8. The system of claim 1, wherein the underlying structure or structural component comprises a framing structure or a plurality of studs.

9. The system of claim 2, wherein the first adhesive layer comprises a butyl-based or acrylic-based adhesive.

10. The system of claim 2, wherein the foam core layer comprises foam polymer insulation.

11. A method for constructing a building structure, the method comprising:
adhering an insulation tape to some or all of an outer surface of an underlying structure or structural component;
fastening a first panel with an inner surface, an outer surface, and one or more edges to the underlying structure or structural component, wherein the first panel is positioned so that an edge of said one or more edges is aligned with the insulation tape, and a portion of the inner surface of the first panel extends over a portion of the insulation tape; and
fastening a second panel with an inner surface, an outer surface, and one or more edges to the underlying structure or structural component, wherein the second panel is positioned so that an edge of said one or more edges is aligned with the insulation tape, and a portion of the inner surface of the second extends over a portion of the insulation tape;
wherein the first panel and second panel are affixed with the respective edges aligned adjacent and in proximity to each other to form a joint, and the insulation tape underlies the joint.

12. The method of claim 11, wherein the first panel and second panel comprise insulation siding panels and/or insulation structural sheathing panels.

13. The method of claim 11, wherein the step of adhering an insulation tape comprises removing a first liner from a first adhesive layer on a first side of a foam core of the insulation tape, and pressing the first side against said outer surface of the underlying structure or structural component.

14. The method of claim 13, further comprising the step of:
after the step of pressing the first side against said outer surface, removing a second liner from a second adhesive layer on a second side of the foam core of the insulation tape.
